(19) United States
(12) Patent Application Publication
(10) Pub. No.: US 2024/0250340 A1
(43) Pub. Date: Jul. 25, 2024

(54) BATTERY SYSTEM FOR A VEHICLE

(71) Applicant: VOLVO TRUCK CORPORATION, Göteborg (SE)

(72) Inventor: Ya LIU, Göteborg (SE)

(73) Assignee: VOLVO TRUCK CORPORATION, Göteborg (SE)

(21) Appl. No.: 18/394,065

(22) Filed: Dec. 22, 2023

(30) Foreign Application Priority Data
Jan. 19, 2023 (EP) 23152495.0

(51) Int. Cl. H01M 10/6568; H01M 10/613; H01M 10/625; H01M 10/653; H01M 10/6551; H01M 10/6552; H01M 10/6556

(52) U.S. Cl. CPC H01M 10/6568; H01M 10/613; H01M 10/625; H01M 10/653; H01M 10/6551; H01M 10/6552; H01M 10/6556; B60L 50/60; H01M 2220/20

(57) ABSTRACT

A battery system for a vehicle is provided. The battery system comprising a battery module and a cooling system, wherein the battery module comprises a battery unit with one or more battery cell. The cooling system includes a cooling circuit comprising tubing for distribution of a cooling fluid and cooling of the one or more battery cell, the tubing comprising a battery cooling section routed along the battery unit, and one or more heat conduction elements arranged to at least partially wrap around the battery cooling section and be in contact with at least a portion of the battery unit.

### TECHNICAL FIELD

The disclosure relates generally to a battery system. In particular aspects, the disclosure relates to a battery system of a vehicle. The disclosure can be applied in heavy-duty vehicles, such as trucks, buses, and construction equipment. Although the disclosure may be described with respect to a particular vehicle, the disclosure is not restricted to any particular vehicle.

### BACKGROUND

Li-ion batteries are highly desired as power sources for hybrid and electric vehicles (HEV/EV) due to their high energy density and outstanding cycling stability. However, the capacity and lifetime of Li-ion batteries are very sensitive to high as well as low temperatures. As the temperature falls to below −10° C. or becomes higher than 25° C., the capacity of Li-ion battery deteriorates drastically.

Furthermore, the Li-ion batteries suffer from temperature increase during charging and discharging. In some cases the temperature of the batteries can exceed 90° C., which may cause a decrease in the capacity of the battery as well cell shorting and other safety issues.

Another issue with the use of Li-ion batteries is that the temperature distribution within the pack commonly is uneven due to each cell often having a slightly different impedance, which in turn may result in a shorter lifespan of the batteries.

Conventional cooling system for batteries often implement traditional fan or water cooling, making the cooling systems heavy and complex in order to provide sufficient cooling for the battery system.

### SUMMARY

According to a first aspect of the disclosure, a battery system for a vehicle is provided. The battery system may comprise a battery module and a cooling system. The battery module may comprise a battery unit with one or more battery cell.

The cooling system may comprise a cooling circuit. The cooling circuit may comprise tubing for distribution of a cooling fluid and cooling of the one or more battery cell. The tubing may comprise a battery cooling section routed along the battery unit.

The cooling system may comprise one or more heat conduction elements arranged to at least partially wrap around the battery cooling section. The one or more heat conduction elements may be arranged to be in contact with at least a portion of the battery unit.

The first aspect of the disclosure may seek to achieve a battery system allowing for efficient cooling. The first aspect of the disclosure may additionally or alternatively seek to achieve a battery system allowing for a more even temperature distribution in the battery unit. A technical benefit may include that the battery unit and thus the battery cells may operate at lower temperatures, thereby mitigating deteriorating capacity and increasing the expected lifespan of the battery system.

In some examples, the cooling system may comprise a heat exchanger. The heat exchanger may be arranged in the cooling circuit downstream from the battery cooling section. A technical benefit may include a more efficient cooling of the battery system.

In some examples, the one or more heat conduction elements may be arranged to wrap around at least a portion of the battery unit. A technical benefit may include an increased contact surface area between the battery unit and the heat conduction element(s), causing an increase in heat dissipation from the battery unit.

In some examples, the one or more heat conduction elements may be arranged to extend along a first surface of the battery unit. A technical benefit may include that the surface is at least partially covered allowing for even temperature distribution across the battery unit. Another technical benefit may be that the extension of the one or more heat conduction element increases the contact surface area between the battery unit and the heat conduction element thus increasing the heat dissipation from the battery unit.

In some examples, the one or more heat conduction elements may be arranged adjacent to the first surface of the battery unit. The one or more heat conduction elements may be arranged to be in contact with a surface of the battery cooling section facing away from the first surface of the battery unit such that the tubing is arranged between the battery unit and the one or more heat conduction elements. A technical benefit may include a further increased contact surface area between the heat conduction element and the battery unit. Another technical benefit may include that the heat conduction element may at least partially seal off the tubing from the other components of the battery system which may prevent potential leakage of cooling fluid from the tubing influencing other components of the battery system.

In some examples, the battery unit may have a second and third surface arranged opposite to each other and extending in a direction substantially orthogonal to the first surface. The one or more heat conduction elements may be arranged to extend along and in contact with the second and/or third surface. A technical benefit may include that the one or more heat conduction elements may at least partially wrap around the battery unit allowing for a more even temperature distribution in the battery unit. Another technical benefit may include an increased heat dissipation from the battery unit due to the increased contact surface area between the one or more heat conduction elements and the battery unit.

In some examples, the battery module may comprise a battery housing adapted to accommodate the battery unit. A technical benefit may include that the battery housing allows for a more predictable and optimizable environment for the battery unit in terms of temperature and other aspects potentially impacting the performance of the battery unit.

In some examples, the heat exchanger may be arranged outside of the battery housing. A technical benefit may include that the risk for heat dissipation of the components arranged inside the housing negatively impacting the cooling performance of the heat exchanger.

In some examples, the one or more heat conduction elements may be arranged to be in contact with the battery housing for dissipating heat from the battery unit to said battery housing. A technical benefit may include that the heat generated by the battery unit also may be dissipated to the housing, thus resulting in a more even temperature distribution in the battery unit and a generally improved rate of heat dissipation.

In some examples, the one or more heat conduction elements may be provided as a film or a foil. A technical benefit may include that a film or foil may be shaped and deformed in order to closely wrap around the battery unit and the tubing. Another technical benefit may further include that a film or foil is more cost-efficient and adaptable for different dimensions of battery units compared to rigid heat conduction elements.

In some examples, the interior walls of the battery housing may be clad with a layer of a heat conductive material such as graphite, aluminum, copper and/or graphene. A technical benefit may include that the clad walls allows for further heat dissipation from the battery unit due to the layer of the heat conductive material enhancing the heat dissipation from the battery unit to the battery housing.

In some examples, the layer of heat conductive material may encapsulate the battery unit from the battery housing. A technical benefit may include that the layer of heat conductive material may allow for a sealing of the interior of the battery casing and may thus prevent leakage of cooling fluid for example in the case of a leak in the tubing.

In some examples, the one or more heat conduction elements may comprise graphite, aluminum, copper and/or graphene. A technical benefit may include that such materials allows for heat transfer at a rapid rate, thereby increasing the efficiency of the cooling the battery unit.

In some examples, the battery cooling section of the tubing may comprise tubing in graphite and/or graphene. A technical benefit may include that the walls of the tubing allows for a more rapid heat transfer to the cooling medium, thereby increasing the efficiency of the cooling of the battery unit.

In some examples, the battery cooling section may comprise a meandering tube portion or labyrinth tube portion routed along the battery unit. A technical benefit may include that an increased heat dissipation from the battery unit is achieved due to an increased surface area of the battery unit being capable of dissipating heat to the cooling fluid in the tubing.

In some examples, the battery unit may at least partially be submerged in a cooling liquid inside the battery housing. A technical benefit may include that a more even temperature distribution of the battery unit is achieved due to cooling liquid distributing the heat dissipated from the battery unit.

In some examples, the cooling circuit may be a closed cooling circuit for circulating the cooling fluid. A technical benefit may include that a more cost-efficient and less complex battery system is achieved.

In some examples, the cooling system may form a heat pipe cooling system. The tubing may have an inner wick structure for causing flow of the cooling fluid by means of capillary force. A technical benefit may include that the efficiency of the cooling of the battery unit and battery cells is improved due to the improved cooling achievable with a heat pipe cooling system.

In some examples, the heat pipe cooling system may comprise a condensing arrangement. The condensing arrangement may be adapted to condense the cooling fluid downstream of the battery cooling section. The condensing arrangement may comprise a condensing unit such as a heat sink and/or a cooling fan.

In some examples, the battery system may comprise a pump. The pump may be arranged in the cooling circuit. The pump may be configured to control the flow of the cooling fluid through the cooling circuit. A technical benefit may include that the flow of cooling fluid may be adapted in accordance with the conditions present.

In some examples, the cooling system may comprise a heat exchanging arrangement for cooling the cooling fluid in the cooling circuit. The heat exchanging arrangement may comprise the heat exchanger arranged in the cooling circuit downstream from the battery cooling circuit. Additionally or alternatively, the heat exchanging arrangement may comprise the inner wick structure.

In some examples, the one or more heat conduction elements may be arranged to coat the outer exterior surface of at least a portion of the battery cooling section. A technical benefit may include that an increased heat dissipation from the battery cooling section may be achieved.

According to a second aspect of the disclosure, a vehicle may be provided. The vehicle may comprise a battery system according to any of the above examples. The second aspect of the disclosure may seek to achieve a vehicle with an increased battery service life and reliability. A technical benefit may include that the battery unit of the vehicle may operate at lower temperatures, thus increasing the efficiency and lifespan of the battery system.

In some examples, the battery system may be configured to power a propulsion source of the vehicle. A technical benefit may include a more efficient propulsion due to the battery system operating within a temperature interval allowing for a more efficient operation.

The above aspects, accompanying claims, and/or examples disclosed herein above and later below may be suitably combined with each other as would be apparent to anyone of ordinary skill in the art.

Additional features and advantages are disclosed in the following description, claims, and drawings, and in part will be readily apparent therefrom to those skilled in the art or recognized by practicing the disclosure as described herein.

### BRIEF DESCRIPTION OF THE DRAWINGS

With reference to the appended drawings, below follows a more detailed description of aspects of the disclosure cited as examples.

FIG. 1 is an exemplary battery system according to one example.

FIG. 2 is an exemplary battery system according to one example.

FIG. 3 is an exemplary battery system according to one example.

FIG. 4 is another view of FIG.2-3, according to another example.

FIG. 5 is a cross-section of a portion of the tubing of a battery cooling system of a battery system according to one example.

### DETAILED DESCRIPTION

Aspects set forth below represent the necessary information to enable those skilled in the art to practice the disclosure.

The present inventor has realized that for an improved and/or ideal Li-ion battery package, the optimal temperature difference within the pack is required to be less than 5° C. which requires a high efficiency cooling system. Thus, the present inventor has realized that an even temperature distribution is of great importance for the performance, capacity and lifespan of the batteries.

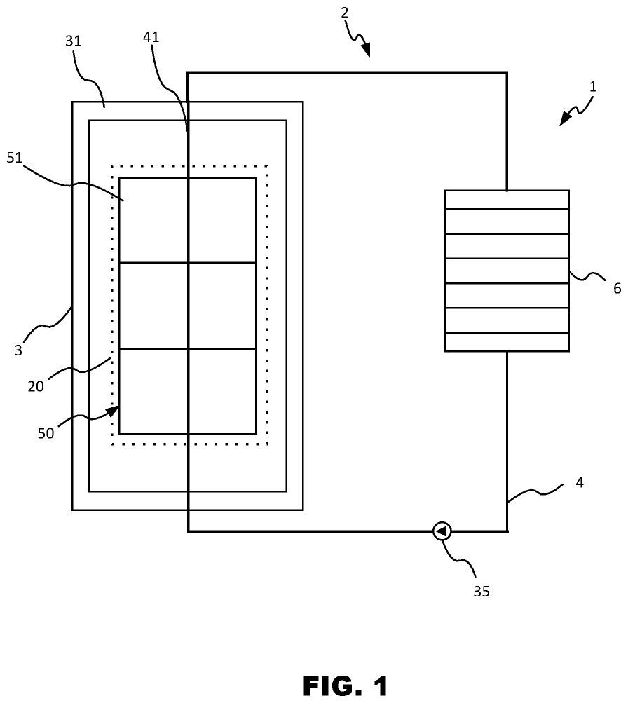

FIG. 1 is an exemplary battery system 1. The battery system 1 is intended for a vehicle. The vehicle may be a heavy-duty vehicle, such as a truck, bus, or construction equipment. The vehicle may also be a passenger car. The battery system 1 may be considered a vehicle battery system. It may however also be envisioned that the battery system may be utilized in other systems comprising a battery system requiring cooling.

The battery system 1 may comprise a battery module 3. The battery system 1 may further comprise a cooling system 2. The cooling system 2 may be adapted to cool the battery unit 50. The cooling system 2 may be adapted to cool the one or more battery cell 51.

The battery system 1 may be intended to power any component of the vehicle. Preferably, the battery system 1 may be configured to power a propulsion source of the vehicle. The propulsion source may thus be an electrical motor adapted to propel the vehicle.

The battery module 3 may comprise a battery unit 50. The battery unit 50 may comprise one or more battery cell 51. The cooling system 2 may be adapted to cool the battery unit 50 and thus the one or more battery cell 51 of the battery unit 50.

In the depicted example, the battery unit 50 comprises a plurality of battery cells 51. The battery cells 51 in the depicted example are arranged in three parallel stacks. It may however be envisioned that the battery cells 51 may be arranged in any conceivable configuration. It may also be envisioned that the battery unit 50 comprises a single battery cell 51.

The cooling system 2 may comprise a cooling circuit 4. The cooling circuit 4 may comprise tubing 42 for distribution of a cooling fluid and cooling of the one or more battery cell 51. Thus, the tubing 42 is adapted to guide a cooling fluid and thereby cool the one or more battery cell 51. The tubing 42 may be in any form of conventional type of tubing suitable for a cooling system such as pipes, hoses etc.

The tubing 42 may comprise a battery cooling section 41. The battery cooling section 41 may be routed along the battery unit 50. Thus, the battery cooling section 41 may be considered a part of the tubing arranged to extend along the battery unit 50 in order to enable heat transfer from the battery unit 50, e.g. the battery cell(s) 51 of the battery unit 50, to the cooling fluid flowing through the battery cooling section 41.

The cooling system 2 may further comprise a heat exchanger 6. The heat exchanger may be arranged in the cooling circuit 4. The heat exchanger 6 may be arranged downstream from the battery cooling section 41.

The tubing 42 may be adapted to guide the cooling fluid through the heat exchanger 6 after passing the cooling fluid along the battery unit 50.

In one example, a portion of the tubing may extend through the heat exchanger 6.

In one example, the tubing 42 may be fluidly connected to the heat exchanger 6. Thus, the tubing 42 may be fluidly connected to a heat exchanger inlet of the heat exchanger 6. Correspondingly, the tubing 42 may be fluidly connected to a heat exchanger outlet of the heat exchanger 6. The tubing 42 may be attached to the heat exchanger 6 by means of an adhesive such as glue or by means of welding. For example, if the tubing is in a high thermal conductivity material such as graphite and/or graphene, glue may be suitable for attaching the tubing 42 to the heat exchanger 6. If the tubing is in a metal material such as copper or aluminum, welding may be suitable for attaching the tubing 42 to the heat exchanger 6.

The cooling system 2 may comprise a heat exchanging arrangement for cooling the cooling fluid in the cooling circuit 4. As will be described with reference to FIG. 5, the heat exchanging arrangement may in addition or alternatively comprise an inner wick structure of the tubing.

In order to enable an even temperature distribution in the battery unit and increase the heat exchange rate between the cooling fluid and the battery unit and battery cells, one or more heat conduction elements 20 may be utilized.

Thus the cooling system 2 may comprise the one or more heat conduction elements 20. The one or more heat conduction elements 20 may be arranged to at least partially wrap around the battery cooling section 41. The one or more heat conduction elements 20 may be arranged to be in contact with at least a portion of the battery unit 50.

Advantageously, the one or more heat conduction elements 20 may be arranged to wrap around at least a portion of the battery unit 50. Accordingly, one or more heat conduction element 20 may be arranged to at least partially wrap around the battery cooling section 41 as well as the battery unit 50.

At least partially wrapping around the battery cooling section 41 may herein refer to the one or more heat conduction element 20 wrapping around at least a portion of the battery cooling section 41. The term at least partially wrap and wrapping around at least a portion may thus be considered interchangeable herein. In one example, the one or more heat conduction element 20 may fully wrap around the heat conduction element 20 thereby fully surrounding the cross-section of the tubes of the tubing 42 of the battery cooling section 41. In one example, the one more heat conduction element 20 may wrap around a portion of the cross-section of the tubes of the tubing 42. Wrapping around may herein refer to the one or more heat conduction elements 20 extending along an outer circumferential surface section of the cross-section of the tubes of the tubing 42 of the battery cooling section 41. The one or more heat conduction element 20 may be arranged to be in contact with the outer circumferential surface section of the cross-section of the tubes of the tubing 42 of the battery cooling section 41.

The one or more heat conduction element 20 may be adapted to transfer heat from the battery unit 50 to tubing 42, i.e. to the cooling fluid flowing through the tubing 42. In other words, the one or more heat conduction element 20 may be adapted to dissipate heat from the battery unit 50 to the tubing 42, i.e. to the cooling fluid flowing through the tubing 42.

The one or more heat conduction elements 20 may be in a heat conductive material. As the skilled person is aware, a heat conductive material is material enabling a more rapid rate of heat transfer. Due to their properties, such material allows for more efficient heat dissipation from the battery cells and the battery unit.

The heat conductive material may be graphite, aluminum, copper or graphene. The heat conduction elements 20 may comprise graphite, aluminum, copper and/or graphene. In one example, the heat conduction elements 20 may be in graphite, aluminum, copper and/or graphene.

The heat conduction element(s) may be provided in different forms.

In one example, the one or more heat conduction elements 20 may be provided as a film or a foil. In one example, a plurality of heat conduction elements 20 may be provided as a plurality of film or foils.

In one example, the heat conduction elements 20 may be provided as a rigid casing member.

In one example, the one or more heat conduction elements 20 may be provided as a single member, it may however be envisioned that the heat conduction elements 20 may be provided as elements comprising a plurality of members being arranged in contact with each other.

Advantageously, the one or more heat conduction elements 20 may be formed by a single foil or film. Said single foil or film may be arranged to wrap around at least a portion of the tubing 42 and at least a portion of the battery unit 50.

In one example, the one or more heat conduction elements may be arranged to coat the exterior surface of at least a portion of the battery cooling section 41. Thus, a portion of the tubing 42 forming the battery cooling section 41 may be externally coated with the one or more heat conduction elements. Preferably, the battery cooling section 41 may be completely coated with the one or more heat conduction elements such that the entire exterior surface of the battery cooling section 41 is covered in a high thermal conductivity material.

In one example, a pump may be utilized to control the flow of the cooling fluid in the cooling circuit 4. The battery system 1 may thus comprise a pump 35. The pump 35 may be arranged in the cooling circuit 4. The pump 35 may be configured to control the flow of the cooling fluid through the cooling circuit 4.

The pump 35 may be any type of suitable pump for the pumping of a cooling fluid such as a positive displacement pump. In one example, the pump 35 may be configured to be operatively connected to a control unit for controlling of the operation of the pump 35.

Advantageously, an outlet of the cooing circuit 4 may be fluidly connected to an inlet of the pump 35 and an inlet of the cooling circuit 4 may be fluidly connected to an outlet of the pump 35. The pump 35 may be adapted to circulate the cooling fluid through the cooling circuit 4. The pump 35 may be driven by means of any conventional source. For example, the pump 35 may be an electrical pump powered by the battery module 3 or a separate battery electrically connected to the pump 35. The pump 35 may be a mechanically driven pump, such as a gear driven pump, connected to a rotating shaft, e.g. a rotating shaft of the vehicle.

The pump 35 may be arranged downstream of the battery cooling section 41. Thus, the outlet of the cooling circuit 4 fluidly connecting to the pump 35 may be arranged downstream of the battery cooling section 41.

The cooling circuit 4 may be a closed cooling circuit for circulating the cooling fluid. The closed cooling circuit may thus be a closed loop cooling circuit. In one example, the pump 35 may form a part of the closed cooling circuit.

The battery module 3 may comprise a battery housing 31. The battery housing 31 may be adapted to accommodate the battery unit 50. The battery housing 31 may accommodate the battery unit 50. The battery housing 31 may be in metal such as steel or aluminum. In one example, the battery housing 31 may be adapted to encapsulate the battery unit 50.

In one example, the battery unit 50 may be mounted to the battery housing 31. Depending on the type of cells implemented in the battery unit 50, different types of mountings may be utilized. In one example, the battery unit 50 may be fastened to the battery housing 50 by means of an adhesive such as glue or one or more fasteners such as screws. In one example, the adhesive may be in a material with high thermal conductivity.

In one example, the battery unit 50 may be mounted to the battery housing 31 by means of a bus bar. The bus bar may be in a material with high thermal conductivity.

In one example, cooling liquid may be present inside the battery housing 31 in order to further enhance cooling of the battery unit 50. The battery unit 50 may be at least partially submerged in the cooling liquid inside the battery housing 31. The cooling liquid may be water such as deionized water or any other conventional type of cooling liquid such as glycol. The battery housing 31 may be adapted to sealingly encapsulate the battery unit 50 and thereby prevent leakage of the cooling liquid inside the battery housing 31 out of the battery housing 31. At least partially submerged herein refers to the battery unit 50 to that at least a portion or the entire battery unit 50 may be arranged in the cooling liquid. Hence, worded differently, at least a portion of the battery unit 50 may be submerged in the cooling liquid. In one example, the battery unit 50 may be fully submerged in the cooling liquid.

Advantageously, the heat exchanger 6 may be arranged outside the battery housing 31. To further avoid heat generation inside the battery housing 31, the pump 35 may be arranged outside the housing 31. Thus, the heat generated from the pump 35 during operation is not accumulated inside the battery housing 31 negatively impacting the cooling performance.

In one example, the battery cooling section 41 of the tubing 42 may comprise tubing in graphite and/or graphene. Thus, the part of the tubing 42 forming the battery cooling section 41 routed along the battery unit 50 may be in graphite and/or graphene. In one example, the entire tubing 42 or other selected portions of the tubing 42 may be in graphite and/or graphene.

The battery cooling section 41 may be provided in a shape allowing for further heat dissipation from the battery unit 50.

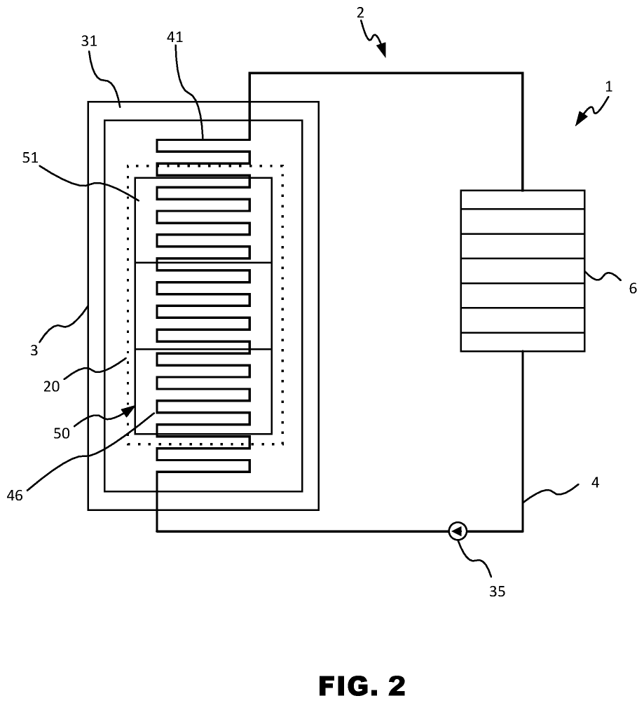

In the example depicted in FIG. 2, the battery cooling section 41 may comprise a meandering tube portion 46. The meandering tube portion 46 may comprise a plurality of interconnected curved portions providing a meandering flow of the cooling fluid along the battery unit 50.

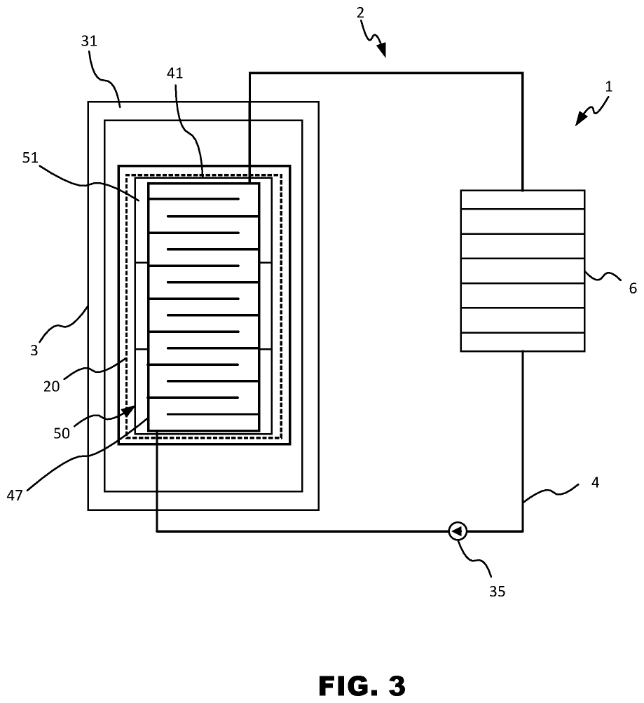

In the example depicted in FIG. 3, the battery cooling section 41 may comprise a labyrinth tube portion 47. The labyrinth tube portion 47 may be adapted to provide a labyrinthine flow path of the cooling fluid along the battery unit 50. The labyrinth tube portion 47 may be formed by a plurality of wall sections distributed inside a housing, thereby forming the labyrinthine flow path for the cooling fluid.

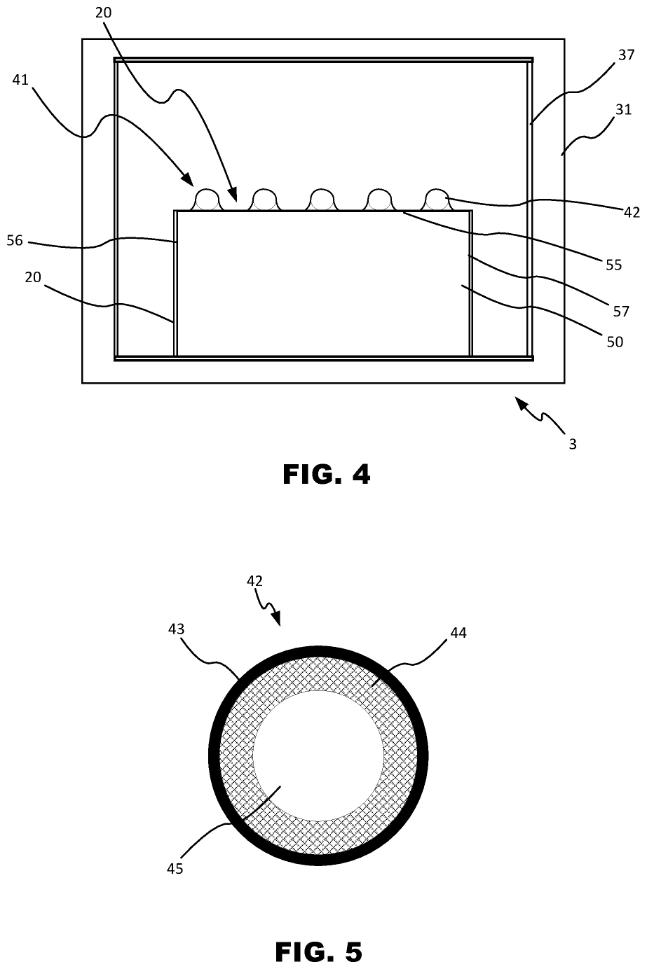

A cross-section of an exemplary battery system 1 is depicted in FIG. 4.

Referencing FIG. 4, the one or more heat conduction elements 20 may be arranged to extend along a first surface 55 of the battery unit 50. In one example, the one or more heat conduction elements 20 may be arranged to extend across the first surface 55.

The one or more heat conduction element 20 may be arranged to at least partially cover the first surface 55 of the battery unit 50. The first surface 55 may be arranged proximate and/or adjacent to the battery cooling section 41. The first battery cooling section 41 may be routed along the first surface 55.

In one example, the one or more heat conduction elements 20 may be arranged adjacent to the first surface 55 of the battery unit 50. The one or more heat conduction elements 20 may be arranged to be in contact with a surface of the battery cooling section 41. Said surface of battery cooling section may face away from the first surface 55 of the battery unit 50 such that the tubing 42 is arranged between the battery unit 50 and the one or more heat conduction elements 20.

The battery unit 50 may have a second surface 56 and a third surface 57. The second surface 56 and the third surface 57 may be arranged opposite to each other. The second surface 56 and the third surface 57 may be arranged to extend in a direction orthogonal to the first surface 55. The one or more heat conduction elements 20 may be arranged to extend along and in contact with the second surface 56 or alternatively or additionally along and in contact with the third surface 57.

The second surface 56 and the third surface 57 may as depicted in FIG. 4 be arranged orthogonally to the first surface 55. It may however be envisioned that the second surface 56 and/or third surface 57 only partially extends orthogonally to the first surface 55, i.e. extends in a direction with a component orthogonal to the first surface 55.

Further referencing FIG. 4, the one or more heat conduction elements 20 may be arranged to be in contact with the battery housing 31 for dissipating heat from the battery unit 50 the battery housing 31.

Advantageously, a portion of the one or more heat conduction elements 20 may extend along and be in contact with the surface of the battery housing 31. This allows for a relatively large contact area between the heat conduction element(s) and the battery housing, increasing the heat dissipation from the battery unit.

Further referencing FIG. 4, the interior walls of the battery housing 31 may be clad with a layer of heat conductive material 37 such as graphite, aluminum, copper and/or graphene.

Advantageously, the layer of heat conductive material 37 may encapsulate the battery unit 50 from the battery housing 31.

As aforementioned, in one example, the cooling system 2 may comprise a single heat conduction element 20. Said single heat conduction element 20 may wrap around at least a portion of the battery cooling section 41 and preferably at least a portion of the battery unit 50. As aforementioned said single heat conduction element 20 may be formed as a single member or a plurality of members arranged in contact with each other.

In one example, the cooling system 2 may comprise a plurality of heat conduction elements 20. The heat conduction elements 20 may be arranged to wrap around at least a portion of the battery cooling section 41 and preferably at least a portion of the battery unit 50. The heat conduction elements 20 may be arranged parallel to each other.

In one example, the cooling system 2 may form a heat pipe cooling system. As the skilled person is aware, a heat pipe cooling system is a cooling system implementing a heat pipe. A heat pipe is a heat-transfer device that employs phase transition and capillary forces to transfer heat. A heat pipe thus utilizes a phase change from liquid to vapor in order to cool a component. At a later stage in the cooling system, the evaporated fluid is condensed back into liquid releasing the latent heat from the cooling fluid. The cooling fluid may hence be chosen to be a cooling fluid suitable for a heat pipe. The cooling fluid may for example be any one of water, ethanol, methanol, ethane, propylene and pentane, although other conventional cooling fluids also may be suitable.

The heat pipe cooling system may further comprise a condensing arrangement adapted to condense the cooling fluid downstream of the battery cooling section 41. The condensing arrangement may comprise condensing unit such as a heat sink and/or a cooling fan. The heat exchanging arrangement may hence comprise the inner wick structure and the condensing arrangement. In one example, a cooling fan may be utilized to cool the cooling fluid, thereby causing condensation of the cooling fluid. This may be achieved for example by means of directing a cooling air flow onto the tubing 42. In one example, a heat sink is arranged in the cooling circuit 4 to cool the cooling fluid, thereby causing condensation of the cooling fluid. In one example, a heat sink and cooling fan may be utilized in combination to cause condensation the cooling fluid.

FIG. 5 depicts a cross-section of the tubing 42 of a cooling system 2 forming a heat pipe cooling system according to one example.

The tubing 42 may have an inner wick structure 44 for causing flow of the cooling fluid by means of capillary force. In one example, the entirety or majority of the tubing 42 may form a heat pipe. In one example, only the battery cooling section 41 may form a heat pipe.

The inner wick structure 44 may be adapted to generate a flow of the cooling fluid by exerting the fluid to movement by means of capillary forces. The inner wick structure 44 may be a porous structure. In one example, the inner wick structure 44 may be in the form of a sintered structure with a surface formed by a sintered powder forming a plurality of pores providing the capillary force. In one example, the inner wick structure 44 may be in the form of machined grooves extending along the tubing in order to provide the capillary force.

The inner wick structure 44 may form an inner wall surrounding the flow passage 45 inside the tubing 42. The inner wick structure 44 is thus adapted to be in contact with the cooling fluid flowing inside the flow passage 45 in order to generate the capillary force controlling the flow of the cooling fluid.

Notably, the above-described heat pipe cooling system may optionally include a pump configured to control the flow of cooling fluid through the cooling circuit. The capillary forces generated by the inner wick structure may be utilized instead of a pump. However, in order to increase the efficiency, a pump as described with reference to FIG. 1-3 may be utilized in conjunction with the inner wick structure in order to achieve the flow of cooling fluid through the cooling circuit.

A battery system and vehicle may be provided in accordance with any of the following examples.

Example 1: Battery system 1 for a vehicle, the battery system 1 comprising a battery module 3 and a cooling system 2, wherein the battery module 3 comprises a battery unit 50 with one or more battery cell 51, and
wherein the cooling system 2 comprises:
a cooling circuit 4 comprising tubing 42 for distribution of a cooling fluid and cooling of the one or more battery cell 51, the tubing 42 comprising a battery cooling section 41 routed along the battery unit 50, and
one or more heat conduction elements 20 arranged to at least partially wrap around the battery cooling section 41 and be in contact with at least a portion of the battery unit 50.

Example 2: Battery system 1 of example 1, wherein the cooling system 2 comprises a heat exchanger 6 arranged in the cooling circuit 4 downstream from the battery cooling section 41.

Example 3: Battery system 1 of example 1 or 2, wherein the one or more heat conduction elements 20 are arranged to wrap around at least a portion of the battery unit 50.

Example 4: Battery system 1 of any of the examples 1-3, wherein the one or more heat conduction elements 20 are arranged to extend along a first surface 55 of the battery unit 50.

Example 5: Battery system 1 of example 4, wherein the one or more heat conduction elements 20 are arranged adjacent to the first surface 55 of the battery unit 50 and the one or more heat conduction elements 20 are arranged to be in contact with a surface of the battery cooling section 41 facing away from the first surface 55 of the battery unit 50 such that the tubing 42 is arranged between the battery unit 50 and the one or more heat conduction elements 20.

Example 6: Battery system 1 of example 4 or 5, wherein the battery unit 50 has a second and third surface 56, 57 arranged opposite to each other and extending in a direction substantially orthogonal to the first surface 55, whereby the one or more heat conduction elements 20 are arranged to extend along and be in contact with the second and/or third surface 56, 57.

Example 7: Battery system 1 of any of the examples 1-6, wherein the battery module 3 comprises a battery housing 31 adapted to accommodate the battery unit 50.

Example 8: Battery system 1 of example 7, wherein the heat exchanger 6 is arranged outside of the battery housing 31.

Example 9: Battery system 1 of example 7 or 8, wherein the one or more heat conduction elements 20 are arranged to be in contact with the battery housing 31 for dissipating heat from the battery unit 50 to said battery housing 31.

Example 10: Battery system 1 of any of the examples 1-9, wherein the one or more heat conduction elements 20 are provided as a film or a foil.

Example 11: Battery system 1 of any of the examples 1-10, wherein the interior walls of the battery housing 31 are clad with a layer of a heat conductive material 37 such as graphite, aluminum, copper and/or graphene.

Example 12: Battery system 1 of example 11, wherein the layer of heat conductive material 37 encapsulates the battery unit 50 from the battery housing 31.

Example 13: Battery system 1 of any of the examples 1-12, wherein the one or more heat conduction elements 20 comprises graphite, aluminum, copper and/or graphene.

Example 14: Battery system 1 of any of the examples 1-13, wherein the battery cooling section 41 of the tubing 42 comprises tubing in graphite and/or graphene.

Example 15: Battery system 1 of any of the examples 1-14, wherein the battery cooling section 41 comprises a meandering tube portion 46 or labyrinth tube portion 47 routed along the battery unit 50.

Example 16: Battery system 1 of any of the examples 7-15, wherein the battery unit 50 is at least partially submerged in a cooling liquid inside the battery housing 31.

Example 17: Battery system 1 of any of the examples 1-16, wherein the cooling circuit 4 is a closed cooling circuit for circulating the cooling fluid.

Example 18: Battery system 1 of any of the examples 1-17, wherein the cooling system 2 forms a heat pipe cooling system, wherein the tubing 42 has an inner wick structure 44 for causing flow of the cooling fluid by means of capillary force.

Example 19: Battery system 1 of any of the examples 1-18, further comprising a pump 35 arranged in the cooling circuit 4, the pump 35 being configured to control the flow of the cooling fluid through the cooling circuit 4.

Example 20: Battery system 1 of any of the examples 1-19, wherein the one or more heat conduction elements 20 are arranged to coat the outer exterior surface of at least a portion of the battery cooling section 41.

Example 21: Vehicle comprising a battery system 1 according to any of the examples 1-20.

Example 22: Vehicle of example 21, wherein the battery system 1 is configured to power a propulsion source of the vehicle.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the inventive concepts being set forth in the following claims.

1. Battery system for a vehicle, the battery system comprising a battery module and a cooling system, wherein the battery module comprises a battery unit with one or more battery cell, and
wherein the cooling system comprises:
a cooling circuit comprising tubing for distribution of a cooling fluid and cooling of the one or more battery cell, the tubing comprising a battery cooling section routed along the battery unit, and
one or more heat conduction elements arranged to at least partially wrap around the battery cooling section and be in contact with at least a portion of the battery unit.

2. Battery system of claim 1, wherein the cooling system comprises a heat exchanger arranged in the cooling circuit downstream from the battery cooling section.

3. Battery system of claim 1, wherein the one or more heat conduction elements are arranged to wrap around at least a portion of the battery unit.

4. Battery system of claim 1, wherein the one or more heat conduction elements are arranged to extend along a first surface of the battery unit.

5. Battery system of claim 4, wherein the one or more heat conduction elements are arranged adjacent to the first surface of the battery unit and the one or more heat conduction elements are arranged to be in contact with a surface of the battery cooling section facing away from the first surface of the battery unit such that the tubing is arranged between the battery unit and the one or more heat conduction elements.

6. Battery system of claim 4, wherein the battery unit has a second and third surface arranged opposite to each other and extending in a direction substantially orthogonal to the first surface, whereby the one or more heat conduction elements are arranged to extend along and be in contact with the second and/or third surface.

7. Battery system of claim 1, wherein the battery module comprises a battery housing adapted to accommodate the battery unit.

8. Battery system of claim 7, wherein the one or more heat conduction elements are arranged to be in contact with the battery housing for dissipating heat from the battery unit to said battery housing.

9. Battery system of claim 1, wherein the one or more heat conduction elements are provided as a film or a foil.

10. Battery system of claim 1, wherein the one or more heat conduction elements comprises graphite, aluminum, copper and/or graphene.

11. Battery system of claim 1, wherein the battery cooling section comprises a meandering tube portion or labyrinth tube portion routed along the battery unit.

12. Battery system of claim 7, wherein the battery unit is at least partially submerged in a cooling liquid inside the battery housing.

13. Battery system of claim 1, wherein the cooling system forms a heat pipe cooling system, wherein the tubing has an inner wick structure for causing flow of the cooling fluid by means of capillary force.

14. Battery system of claim 1, further comprising a pump arranged in the cooling circuit, the pump being configured to control the flow of the cooling fluid through the cooling circuit.

15. Vehicle comprising a battery system according to claim 1.
